(19) United States
(12) Patent Application Publication
(10) Pub. No.: US 2005/0018986 A1
(43) Pub. Date: Jan. 27, 2005

(54) Ring structures in optical fibres

(76) Inventors: Alexander Argyros, Fairfield Heights (AU); Maryanne Candida Jane Large, West Pymble (AU); Mark Geoffrey Sceats, Prymont (AU); Martijn Alexander Van Eijkelenborg, Newtown (AU); Ian Masson Bassett, Wollstonecraft (AU)

Correspondence Address: WOLF GREENFIELD & SACKS, PC;FEDERAL RESERVE PLAZA, 600 ATLANTIC AVENUE, BOSTON, MA, 02210-2211, US

(21) Appl. No.: 10/499,156

(22) PCT Filed: Dec. 17, 2002
(86) PCT No.: PCT/AU02/01702

(30) Foreign Application Priority Data
Dec. 17, 2001 (AU) PR 9499

(51) Int. Cl. G02B 6/20

(52) U.S. Cl. 385/125

(57) ABSTRACT

This invention provides an optical fibre (1) incorporating a body (2), and an array of longitudinally extending holes or inclusions (3) formed in the body (2), the holes or inclusions (3) having a different refractive index from the surrounding body (2) and being arranged to form a full or partial ring structure (5) extending generally around a longitudinal axis of the fibre, the ring structure (5) being disposed so as to approximate the refractive or reflective transmission characteristics of a multi-layer optical fibre. The fibre (1) may have a solid core or a hollow air core. The invention also provides a method of forming the microstructured optical fibre (1).

### FIELD OF THE INVENTION

The present invention relates generally to optical components.

The invention has been developed primarily for use in photonics, and will be described predominantly with reference to this application. It will be appreciated by those skilled in the art, however, that the invention is not limited to this particular field of use.

### BACKGROUND OF THE INVENTION

Conventional optical fibres operate through total internal reflection (TIR) from a refractive index profile of the type incorporated, for example, in step-index or graded index fibres. These fibres have been manufactured from a variety of materials, including silica glass and various types of polymers. However, these fibres are subject to a number of inherent limitations and disadvantages.

For instance, a single mode step index fibre is strictly speaking not single moded; as there are still two degrees of freedom, corresponding to the two polarisation states. Consequently, imperfections and bends in the fibre, manufacturing flaws as well as environmental disturbances can cause the polarisation of light in the fibre to fluctuate. This is a significant disadvantage in optical sensing applications, for example, due to the reduction in fringe contrast resulting from changes in polarisation. It also causes problems in optical data transmission applications due to polarisation mode dispersion.

In an attempt to address some of these limitations, microstructured optical fibres such as photonic crystal fibres and holey fibres have been fabricated in the last few years, most commonly from silica glass. A recent advance in this type of fibre is fabrication from polymeric materials, such as those disclosed in International PCT Patent Application PCT/AU01/00891 dated 20 Jul. 2001. An important feature of this advance is that it eliminates the need to form the microstructure in the fibre by stacking geometric arrays of glass tubes and/or rods. Due to the easier processability of polymers, Microstructured Polymer Optical fibre (NPOF) can be fabricated with almost any desired hole structure, which opens up the way to fabricate a variety of new types of fibres.

Bragg fibres are known, at least in theory, to offer an alternative to the total internal reflection approach for guiding light in optical fibres. In particular, Bragg fibres can guide light through both solid core and air core fibres, with the possibility of reducing fluctuations in polarisation and polarisation mode dispersion. These fibres typically comprise a plurality of concentric layers formed from non-metallic materials of varying refractive index, selected and configured to achieve optimal dielectric reflectivity, with minimal energy absorption. In practice, however, Bragg fibres have not been used in this context to any great extent, because the range of refractive index contrasts achievable between adjacent layers formed from known materials, using existing production techniques, is either relatively small so that a very large number of layers is needed, or is relatively large with the restriction that the materials are incompatible and the structure can not be effectively drawn into an optical fibre.

It is an object of the present invention to overcome or substantially ameliorate one or more of the deficiencies of the prior art, or at least to provide a useful alternative.

### SUMMARY OF THE INVENTION

Accordingly, in a first aspect, the invention provides an optical fibre incorporating a body, and an array of longitudinally extending holes or inclusions formed in the body, the holes or inclusions having a different refractive index from the surrounding body and being arranged to form a full or partial ring structure extending generally around a longitudinal axis of the fibre, the ring structure being disposed so as to approximate the refractive or reflective transmission characteristics of a multi-layer optical fibre.

According to a second aspect, the invention provides a method of forming an optical fibre, said method including the steps of forming a body for the fibre, and forming an array of longitudinally extending holes or inclusions in the body, the holes or inclusions having a different refractive index from the surrounding body and being arranged to form a fall or partial ring structure extending generally around a longitudinal axis of the fibre, the ring structure being disposed so as to approximate the refractive or reflective transmission characteristics of a multi-layer optical fibre.

In one preferred embodiment of the invention, a main body of the fibre is formed substantially from glass or an optical polymeric material, and the inclusions defining the ring structure are substantially filled with air. Advantageously, this approach allows a relatively high refractive index contrast between the fibre material (with a typical refractive index of around 1.5) and the entrained air. It should be appreciated, however, that the inclusions may alternatively contain other materials, such as silica or polymers having different chemical compositions, densities or refractive indices.

In one preferred form of the invention, the fibre incorporates a solid core. In an alternative preferred form, however, the fibre is formed with a hollow air core. The fibre can also be formed with multiple ring structures, ideally concentric in orientation, to simulate a composite optical fibre having a corresponding multiple of constituent layers.

### BRIEF DESCRIPTION OF THE DRAWINGS

A preferred embodiment of the invention will now be described, by way of example only, with reference to the accompanying drawings in which:—

FIG. 1 is a cross-sectional view of a solid core optical fibre incorporating air inclusions defining a single circular ring structure according to a first embodiment of the invention;

FIG. 2 is a cross-sectional view similar to FIG. 1, but showing a solid core fibre incorporating multiple concentric ring structures, according to a second embodiment of the invention; and

FIG. 3 is a cross-sectional view showing a fibre similar to that shown in FIG. 1, but incorporating an air core.

### DESCRIPTION OF PREFERRED EMBODIMENT

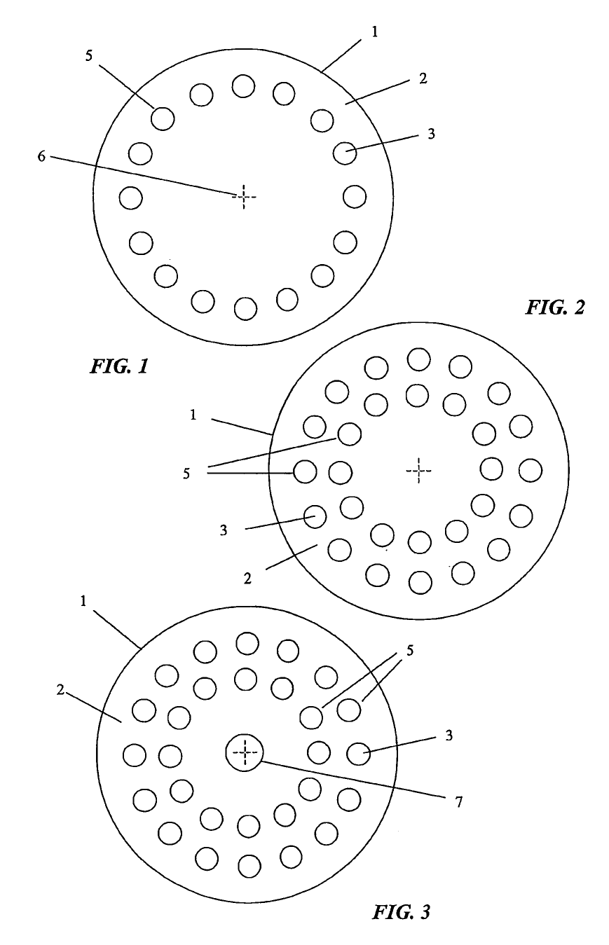

Referring to the drawings, the invention provides an optical fibre 1 incorporating a body 2, and a plurality of longitudinally extending holes or inclusions 3 formed in the body. In the arrangement shown in FIG. 1, the holes are disposed in a circular array to define a ring structure 5 extending coaxially around a longitudinal axis 6 of the body of the fibre.

In one preferred configuration, the main body of the fibre is formed substantially from an optical polymeric material, and the inclusions 3 defining the ring structure 5 are substantially filled with air. Advantageously, this approach allows a relatively high refractive index contrast between the fibre material, which has a typical refractive index of around 1.5) and the entrained air, which has a refractive index of 1.0. It should be appreciated, however, that the inclusions may alternatively contain other materials, such as silica or polymers having different chemical compositions, densities or refractive indices.

In the embodiment illustrated in FIG. 1, the fibre incorporates a solid core. In alternative forms, however, the fibre may be formed with an hollow air core 7 (see FIG. 3). It will also be appreciated that multiple ring structures of this type may be formed centrically within a single fibre, as shown in FIG. 2.

The holes or inclusions that collectively define the ring structures may be formed from a variety of production techniques according to the number and configuration of inclusions required, and the desired effective refractive index profile. In one particularly preferred production method, the inclusions are formed by injection of air during the formation of a suitable polymer preform, and subsequent drawing of the preform into a fibre. Alternatively, however, it will be appreciated that the fibre may be formed using more conventional fabrication techniques, including for example the stacking or layering of separate elements such as capillaries, canes, rods or disks in predetermined geometric configurations, to form a composite body or preform incorporating suitable circumferential arrays of inclusions, cavities or holes.

It will also be appreciated that heat may be selectively applied to regions of the optical fibre body to alter the size of inclusions contained therein, and thereby alter the resultant refractive index profile. More specifically, ultraviolet, infrared, microwave or other forms of radiation may be applied to the body to increase the temperature, locally or overall, and thereby increase the size of selected air inclusions. Alternatively, such radiation may be used to initiate release of air or other gas from a porogen included in the polymeric body of the fibre.

In another production method, the optical component may incorporate a layer of material containing inclusions, which surround a solid core of glass or polymeric optical material. For example, a jacket of material including a circumferential array of inclusions may be applied to a solid core of glass or polymeric optical material by passing it through a bath of partially polymerised material and then curing the jacket by means of ultraviolet radiation.

It should be appreciated that these and other manufacturing techniques may be applied to produce a preform to facilitate the subsequent drawing of an optical fibre, or may alternatively the used to form the optical fibre component directly. Such techniques may include mechanical boring, water drilling, ultrasonic drilling, and the like. It will also be appreciated that the ring structures of the present invention may be used in conjunction with conventional multi-layer fibre manufacturing techniques, to produce hybrid refraction, reflection, transmission or dispersion effects.

An important aspect of the present invention is the realisation that a ring structure or structures of this type may be arranged to approximate the refractive or reflective transmission characteristics of a multi-layer optical fibre. One particularly significant benefit flowing from this is that the ring structures may be sized, spaced and configured to make use of transverse Bragg effects. This in turn opens up a range of potential applications, some of which are outlined below.

Solid Core and Air Core Bragg Fibres

As previously noted, Bragg fibres are known to offer an alternative approach to conventional “photonic crystal fibres” (PCFs) for guiding light in solid core or air core fibres. Bragg fibres have not been greatly used in this context because the range of refractive index contrasts possible with existing techniques is relatively small. However with the relatively large index contrasts provided by the present invention, it is possible to make both solid core and air core fibres, which make effective use of Bragg effects. Moreover, these fibres will be less sensitive to manufacturing variability than conventional PCFs, because they rely on what is essentially a 1-dimensional, rather than a 2-dimensional structure.

While a variety of techniques that could be used to produce high index contrasts, the present invention provides a particularly advantageous techniques for producing high contrast Bragg fibres, whereby the ring structure formed from air holes approximates the effect of concentrically arranged multilayer fibres. As previously indicated, this can provide a contrast in refractive index of at least 0.4, depending on the geometry and packing density of the holes. In PCFs, air guidance can be obtained if the periodicity of the holes is carefully maintained in two dimensions.

In holey Bragg fibres, the holes are simply used to obtain a ring of a particular effective index. This combining or “averaging” of the matrix and hole indices is possible with a large variety of hole patterns. Because the operation and performance of the fibre are based on an averaging effect, the exact position of the holes is much less important than in conventional PCFs. This approach therefore enables the production of air guiding fibres much more easily than in PCFs. As previously indicated, solid core fibres are also possible using this approach.

Truly Single Mode Fibres

“Single mode” conventional fibres have a fundamental HE mode that is degenerate. In ideal fibres with no defects this does not cause problems, but the presence of defects can make the fibres birefringent, and cause polarisation mode dispersion. Using ring structures it is possible to design fibres that utilise the Brewster condition, and produce a fundamental TE mode which is non degenerate. Using this technique it is possible to make both air core and solid core fibres that are genuinely single mode. Inportantly, this method of producing truly single mode fibre results in a fibre that is rotationally symmetric, which greatly enhances the ease with which they can be connected to other optical elements.

Wavelength Discriminating Fibres

Bragg structures are inherently wavelength specific. By making the fibres to appropriate specifications it is possible to regulate the leakage and guidance of wavelengths in a controlled manner. In other words, it is possible selectively to eliminate modes that are unwanted, or to enhance desired modes.

“Fishy” Fibres

Fishy Fibres are those that use the same principle as reflective fish skin to obtain a broad band all-dielectric reflectance. Fish skin uses randomised layers of high refractive index material (guanine with RI of around 1.83) and relatively low refractive index material (cytoplasm with RI of around 1.33) within a defined thickness range to give a highly reflective surface whose properties are independent of bending and other deformations. The thicknesses of the layers are such that they cover the Bragg condition for the desired wavelength range. Using the present invention, a similar system can be used in the production of both air core and solid core fibres. These fibres consist of layers of high and low refractive index rings, with the thickness and refractive indices of the rings being such that the overall effect is to provide broad band “metalicised” reflectance in the desired frequency range. Significantly, this reflectance is not sensitive to bending and other perturbations in the fibre, including manufacturing variations. In fact, variability in manufacturing would confer an advantage, because increasing randomness broadens the peaks and reduce the wavelength specificity. This characteristic confers a significant benefit in a production context in the sense that the “worse” the fibres are made, the better they perform. Such fibres may be formed in hollow or solid core configurations, to provide air guidance over a broad frequency range, together with manufacturing robustness. It is also important to note that this principle could be used to achieve broad band reflectance in other components.

In an alternative but equivalent approach, the layers of thicknesses of the layers may be varied in a systematic rather than a random way. Such a structure could be referred to as a “chirped” structure. This would, similarly, have the effect of broadening the frequency response of the structure.

A further potential advantage over conventional optical fibres is that owing to the localised difference in refractive indices between the hole and the matrix there is less sensitivity to the exact positioning of the holes than is the case for conventional photonic crystal structures. The latter rely on the perfection of a two dimensional lattice structure, which in practice makes their manufacture extremely demanding for band gap structures.

Structural Graded Index Fibres

Concentric ring structures can also be used to produce refractive index profiles of choice, such as that conventionally used in graded index fibres. Such fibres are generally produced by radial variations in the concentrations of a chemical dopant. This is particularly problematic in polymer fibres, for which there is no equivalent of the MCVD (Modified Chemical Vapour Deposition) process. Advantageously, however, according to the present invention such fibres can be produced by structural means.

Laser Cavities

A simple way of making laser cavities is to use short lengths of fibre with reflective ends, which tend to lase in unison. The present invention may be conveniently adapted to this purpose. In addition, a system of stacked lasing Bragg capillaries may couple coherently together to produce a large diameter high power source.

Bragg Fibres as Modal Filters

Some fibres (prominently Bragg fibres) have no guided modes in the straight and narrow sense. They may, however, have some modes which are distinguished from others by the fact that they are almost guided, in the sense of having only very low leakage rates. Such fibres may in practice be comparably single moded (or few moded) as conventional fibres. The key property of such fibres which distinguishes some modes from others is the relative loss rates. Such fibres, as well as their conventional cousins, are modal filters, transmitting the guided or effectively guided modes, and discarding the rest.

There is another way in which a waveguide or fibre may become a modal filter by differential loss. Instead of lealing or radiating away power in the unwanted modes, that power might be absorbed. Differential absorption could be achieved by decorating the nodes of the wanted modes with absorbing material. It is possible also to decorate the peaks of the wanted modes with gain material.

The decoration of the waveguide with gain and loss materials may seem at first glance a blunt instrument to use. However, if the fibre has enough gain to form a laser when suitably pumped, the laser will select one particular transverse mode over all others on the basis of quite small relative advantage, and one could hope to produce a clean mode profile. This profile would be affected by the distribution of the loss material and would not be a mode profile in the ordinary sense, but rather the profile of a field which is stationary (not static) under translation in space along the fibre axis, as well as in time.

It will be appreciated that the invention provides an efficient and reliable optical component, which is capable of operating as a Bragg fibre with relatively high refractive index contrasts, yet in a simple configuration, without the cost and complexity typically associated with the manufacture of multi-layer fibres. Such components offer a high degree of flexibility and versatility, being readily adaptable to a variety of photonics applications. In these respects, the invention represents a practical and a commercially significant improvement over the prior art.

Although the invention has been described with reference to specific examples, it will be appreciated by those skilled in the art that the invention may be embodied in many other forms.

1. An optical fibre incorporating a body formed substantially from optical polymeric material, and an array of longitudinally extending inclusions formed in the body, the inclusions having a different refractive index from the surrounding body and being arranged to form a full or partial ring structure extending generally around a longitudinal axis of the fibre, the ring structure being disposed so as to approximate the refractive or reflective transmission characteristics of a multi-layer optical fibre.

2. The optical fibre as claimed in claim 1 wherein the inclusions are disposed in a circular array to define a ring structure extending coaxially along the longitudinally axis of the body of the fibre.

3. The optical fibre as claimed in claim 1 or 2 wherein the fibre is formed with a solid core.

4. The optical fibre as claimed in any one of claims 1 to 2 wherein the fibre is formed with a hollow core.

5. The optical fibre as claimed in claim 1 wherein the optical fibre comprises a solid core surrounded by said body formed substantially from optical polymeric material containing said inclusions.

6. The optical fibre as claimed in claim 1 wherein the ring structure formed from air holes approximates the effect of concentrically arranged multi-layer fibres.

7. The optical fibre as claimed in claim 1 wherein two or more ring structures are formed by the inclusions.

8. The optical fibre as claimed in claim 7 wherein said two or more ring structures are concentrically arranged around the longitudinal axis of the fibre.

9. The optical fibre as claimed in any one of the preceding claims wherein the inclusions are filled with air.

10. The optical fibre as claimed in anyone of the preceding claims wherein the inclusions are filled with other materials.

11. The optical fibre as claimed in claim 1 configured to perform as a Bragg fibre.

12. The optical fibre as claimed in claim 1 wherein the fibre includes layers of high and low refractive index rings.

13. The optical fibre as claimed in claim 1 wherein said ring structures are configured to produce a graded refractive index profile.

14. The optical fibre as claimed in claim 1 configured to provide single mode optical transmission characteristics.

15. A method of forming an optical fibre, said method including the steps of forming an array of longitudinally extending holes or inclusions in a body of optical polymeric material, the holes or inclusions having a different refractive index from the surrounding body and being arranged to form a fall or partial ring structure extending generally around a longitudinal axis of the fibre, the ring structure being disposed so as to approximate the refractive or reflective transmission characteristics of a multi-layer optical fibre, and subsequently drawing the body into said optical fibre.

16. The method as claimed in claim 15 wherein the inclusions are formed by injection of air during the formation of a suitable polymer preform.

17. The method as claimed in claim 15 wherein heat is selectively applied to regions of the optical fibre body to alter the size of inclusions contained therein, and thereby alter the resultant refractive index profile.

18. The method as claimed in claim 15 wherein ultraviolet, infrared or microwave radiation is applied to the body to increase the temperature, locally or overall, and thereby increase the size of selected air inclusions.

19. The method as claimed in claim 15 wherein said body of optical polymeric material is applied to a solid core by passing it through a bath of partially polymerised material and subsequently curing said partially polymerised material by means of ultraviolet radiation.

20. The method as claimed in claim 15 wherein radiation is used to initiate release of air or other gas from a porogen included in the polymeric body of the fibre so as to form said holes or inclusions in the body of the fibre.
